(19) United States
(12) Patent Application Publication
(10) Pub. No.: US 2015/0377694 A1
(43) Pub. Date: Dec. 31, 2015

(54) SYSTEMS AND METHODS FOR REMOTELY SENSING AND ASSESSING COLLISION IMPACTS

(71) Applicant: The Board of Trustees of The University of Alabama, Tuscaloosa, AL (US)

(72) Inventor: W. Steve Shepard, JR., Northport, AL (US)

(21) Appl. No.: 14/747,666

(22) Filed: Jun. 23, 2015

Related U.S. Application Data
(60) Provisional application No. 62/016,777, filed on Jun. 25, 2014.

(51) Int. Cl. G01H 17/00; G01P 15/00; G01L 5/00

(52) U.S. Cl. CPC G01H 17/00; G01L 5/0052; G01P 15/001

(57) ABSTRACT

Various implementations provide systems and methods for remotely detecting and assessing collision impacts using one or more acoustical sensors, such as using acoustical sensors to detect helmet collisions on an athletic playing field. For example, at least one acoustical sensor is disposed adjacent an athletic playing field and remotely from the one or more players on the athletic playing field. A processor of a computing device in communication with the acoustical sensor is configured for identifying whether the acoustical signal indicates a collision event occurred between a helmet and another object. The processor may also be configured for identifying a location on the playing field where the collision event occurred and/or identifying one or more characteristics of the acoustical signal to determine the amount of force, the duration, the speed, the acceleration, and/or the location of the collision event on the helmet.

### CROSS REFERENCE TO RELATED APPLICATIONS

This application claims priority to U.S. Patent Application No. 62/016,777, filed Jun. 25, 2014, entitled “Systems and Methods for Remotely Sensing and Assessing Helmet Collision Impacts,” the content of which is incorporated herein by reference in its entity.

### BACKGROUND

Current technologies for assessing helmet impacts or collision severity utilize one of two common approaches. In one approach, the helmet is instrumented with sensors, typically accelerometers. These sensors measure the resulting motion and correlate that to a potential for head injury. Another more recent approach uses sensors worn directly on the player's head. One example of this type of approach is the Reebok CHECKLIGHT™, which is an elastic cap containing motion sensors worn on the player's head under the helmet. However, outfitting a team with these sensors can be quite expensive. In addition, these approaches require reliable portable power. Furthermore, to be effective at identifying real-time events, a means of communication for the sensors is necessary, and wireless communication may not reliable. Furthermore, updates to the system as well as replenishing the power source are time consuming requirements since each sensor unit must be treated separately.

Accordingly, an improved system and method for detecting and assessing helmet collision impacts is needed.

### BRIEF SUMMARY

Various implementations provide systems and methods for remotely detecting and assessing collision impacts between two objects. For example, some implementations include systems and methods that remotely detect and assess helmet collision impacts on an athletic playing field. In such implementations, at least one acoustical sensor is disposed adjacent an athletic playing field. The acoustical sensor is remotely located from the one or more players on the athletic playing field. A processor of a computing device in communication with and remotely located from the acoustical sensor is configured for: (1) receiving an acoustical signal from the acoustical sensor; and (2) identifying whether the acoustical signal indicates a collision event occurred between a helmet and another object. In a further implementation, the processor may be configured for identifying a location at which the collision event occurred in response to identifying that the collision event occurred; and in response to the location identified being within a boundary of the playing field, storing data associated with the collision event in a memory of the computing device. The processor may also be configured for generating a message related to the collision event for communicating to a display device on the computing device or to a remotely located computing device. In addition, the processor may also be configured for identifying one or more characteristics of the acoustical signal to determine the amount of force, the duration, the speed, the acceleration, and/or the location of the collision event on the helmet.

According to certain implementations, this system eliminates the need for sensors to be mounted in each helmet or on each player's head. Therefore, it may be an affordable option for teams that cannot afford to outfit each player. In addition, updates to the system may be implemented more quickly and less expensively and processes may be improved more rapidly because, according to various implementations, the system provides one master system for acquiring and processing data. Furthermore, because the system is installed at an athletic field, or arena, multiple teams may share the benefits of the system. And, for implementations that use wires for communicating power and data between the acoustical sensors and the computing device, the system avoids wireless communication and power sourcing costs associated with wireless communication and improves the reliability of the system.

In some implementations, the processor is further configured for identifying one or more characteristics of the acoustical signal indicative of the collision event. The one or more acoustical signal characteristics define the acoustic signature of the acoustical signal. For example, the one or more characteristics of the acoustical signal may be selected from the group consisting of: acoustic pressure, acoustic energy, maximum acoustic pressure, signal duration, acoustic pressure at one or more discrete frequencies, acoustic pressure at frequencies corresponding to the free-vibration modes of the helmet, acoustic energy at one or more discrete frequencies, wavelets, acoustic radiation mode maximum amplitude(s), acoustic radiation mode response amplitude versus time, energy in acoustic radiation mode(s), envelope of acoustic radiation mode(s) amplitude, and acoustic radiation mode amplitude decay. In a further implementation, the processor is further configured for calculating an adjustment for the acoustic energy of the received acoustical signal based on a location on the playing field of the collision event. The adjustment is associated with an amount of spreading expected for the acoustic energy as the acoustical signal propagates from the collision event.

In certain implementations, the processor is further configured for converting at least a portion of the acoustical signal to a numerical value associated with an amount of force associated with the collision event, and storing the numerical value in the memory. In addition, in some implementations, the processor is further configured for identifying an energy level of the collision event and storing the identified energy level in the memory. And, in some implementations, the processor is further configured for identifying an amount of force or severity associated with the collision event, storing the identified amount of force, and generating a message comprising the identified amount of force. The processor may also be configured for identifying and storing in the memory a location and direction of impact of the force on the helmet, and the message further comprises the location and direction of impact on the helmet, according to certain implementations. Identifying the amount of force associated with the collision event may also include comparing a maximum acoustic pressure associated with the received signal to a range of expected acoustic pressures associated with each of one or more force amounts and identifying the amount of force associated with the range of expected acoustic pressures that includes the maximum acoustic pressure of the received signal. According to some implementations, identifying whether the acoustical signal indicates the collision event may include comparing a value associated with the acoustical signal to a range of expected values indicating the occurrence of the collision event.

The processor may be further configured for identifying a duration of the collision event, storing the duration in the memory, and generating a message comprising the duration of the collision event, according to some implementations. And, according to certain implementations, the processor is further configured for identifying a speed or acceleration of the collision event, storing the speed or acceleration in the memory, and generating a message comprising the speed or acceleration.

In some implementations, the at least one acoustical sensor comprises a first acoustical sensor, a second acoustical sensor, and a third acoustical sensor. The first, second, and third acoustical sensors are remotely located from each other.

According to various other implementations, a system for correlating a helmet collision event with an acoustical signal signature may include a helmet and an object for colliding with the helmet; at least one acoustical sensor disposed remotely from the helmet and the object; and a computing device comprising a processor and a memory. The processor may be configured for: receiving an acoustical signal from the acoustical sensor at a certain time; receiving collision characteristic data associated with the collision of the helmet and the object at the certain time; and associating the acoustical signal at the certain time with the collision characteristic data.

In some implementations, the collision characteristic data comprises an amount of force at which the object is collided with the helmet, and the processor is further configured for associating the amount of force with an energy level of the acoustical signal associated with the collision event. As another example, the collision characteristic data may comprise a duration for which the object is collided with the helmet, and the processor is further configured for associating the duration with the total acoustic energy of the collision. Alternatively or additionally, the processor may be further configured for associating the duration with the duration of a vibration or acoustic mode signal associated with the helmet characteristics under collision. In some implementations, the collision characteristic data further comprises an impact location on the helmet at which the object is collided with the helmet, and the processor is further configured for associating the impact location with the amplitude of a helmet free-vibration mode or acoustic radiation mode of the acoustical signal associated with the collision event.

According to various other implementations, a system for remotely detecting a collision of at least two objects includes at least one acoustical sensor remotely located from a first object and a second object; and a computing device comprising a processor and a memory. The computing device is remotely located from the first and second objects, and the processor is configured for: receiving an acoustical signal from the acoustical sensor; and identifying whether the acoustical signal indicates a collision event of the first object with the second object.

In addition, various implementations include a system for correlating a collision event between two or more objects with an acoustical signal signature. The system includes at least two objects for colliding with each other; at least one acoustical sensor disposed remotely from the objects; and a computing device comprising a processor and a memory. The processor may be configured for: receiving an acoustical signal from the acoustical sensor at a certain time; receiving collision characteristic data associated with the collision of the objects at the certain time; and associating the acoustical signal at the certain time with the collision characteristic data.

### BRIEF DESCRIPTION OF THE DRAWINGS

The systems and methods are explained in detail in the following exemplary drawings. The drawings are merely exemplary to illustrate the structure of exemplary systems and methods and certain features that may be used singularly or in combination with other features. The invention should not be limited to the implementations shown.

FIG. 1 illustrates a schematic diagram of an athletic field and a system for remotely detecting and assessing a helmet collision event on the athletic field according to one implementation.

FIG. 2 illustrates a schematic diagram of a central computing device according to one implementation.

FIG. 3 illustrates an exemplary acoustical signal received by one of the acoustical sensors in FIG. 1.

FIG. 4 illustrates a schematic diagram of a process of processing the acoustical signals to identify the collision event, the location of the collision event within or outside of boundaries of the playing field, and information related to the characteristics of the collision according to one implementation.

FIG. 5 illustrates energy levels of the acoustical signals as a function of time for helmet impacts at various force levels according to one implementation.

FIGS. 6A and 6B illustrate energy levels of the acoustical signals at various force levels and a possible correlation between the remotely measured acoustic signature and the magnitude of the force on the helmet according to one implementation.

FIG. 7 illustrates a correlation between the acoustic signatures and various collision speeds according to one implementation.

FIG. 8 illustrates a schematic representation of using acoustic radiation modes for assessing impact severity, location on the helmet, and duration of impact for an object colliding with a helmet according to one implementation.

FIG. 9 illustrates a flow chart of a method of detecting a collision event according to one implementation.

FIG. 10 illustrates a flow chart of a method of correlating a collision event with one or more acoustic signatures of acoustical signals according to one implementation.

FIG. 11 illustrates a system for remotely detecting and assessing a collision event between two objects according to one implementation.

### DETAILED DESCRIPTION

Various implementations provide systems and methods for remotely detecting and assessing collision impacts between two objects. For example, some implementations include systems and methods that remotely detect and assess helmet collision impacts on an athletic playing field. In such implementations, at least one acoustical sensor is disposed adjacent an athletic playing field. The acoustical sensor is remotely located from the one or more players on the athletic playing field. A processor of a computing device in communication with the acoustical sensor is configured for: (1) receiving an acoustical signal from the acoustical sensor; and (2) identifying whether the acoustical signal indicates a collision event occurred between a helmet and another object. In a further implementation, the processor may be configured for identifying a location at which the collision event occurred in response to identifying that the collision event occurred; and in response to the location identified being within a boundary of the playing field, storing data associated with the collision event in a memory of the computing device. The processor may also be configured for generating a message related to the collision event for communicating to a display device on the computing device or to a remotely located computing device. In addition, the processor may also be configured for identifying one or more characteristics of the acoustical signal to determine the amount of force, the duration, the speed, the acceleration, and/or the location of the collision event on the helmet.

Various implementations use acoustic measurement(s) to remotely assess the impact severity of two colliding object, such as two helmets, a helmet colliding with another object, such as a ball, puck, a portion of sports gear or athletic equipment worn by another player, a fixed piece of equipment disposed within the boundaries of the playing field, another object that may injure the player, or two other types of objects. For example, when a helmet collides with another object, such as when two football players' helmets collide on the playing field, an impact force is generated. This impact force causes the helmets to vibrate and subsequently radiate acoustic energy or sound. Most sports fans and television viewers have heard this acoustic signature, which mimics a short cracking or popping sound. This radiated impact sound, referred to as the acoustic signature, can be measured remotely using one or more acoustical sensors, such as microphones. By appropriately processing the measured acoustic signature, the severity of the helmet collision (e.g., magnitude of the impact force) associated with that signature can be determined. Because the location of a helmet collision on the field can vary during play, certain implementations may include multiple microphones around the athletic field to determine the location of the collision on the athletic field. With multiple microphones and/or the use of processing algorithms, like wavelets, to isolate the collision signature from the total noise measured, the negative influence of extraneous noise may be reduced. Furthermore, identification of helmet impacts that may be occurring outside of the boundaries of the athletic field, such as from a player throwing a helmet onto a bench, can be identified to reduce false alarms. By detecting a collision event and assessing its severity, the potential for head injury can be determined.

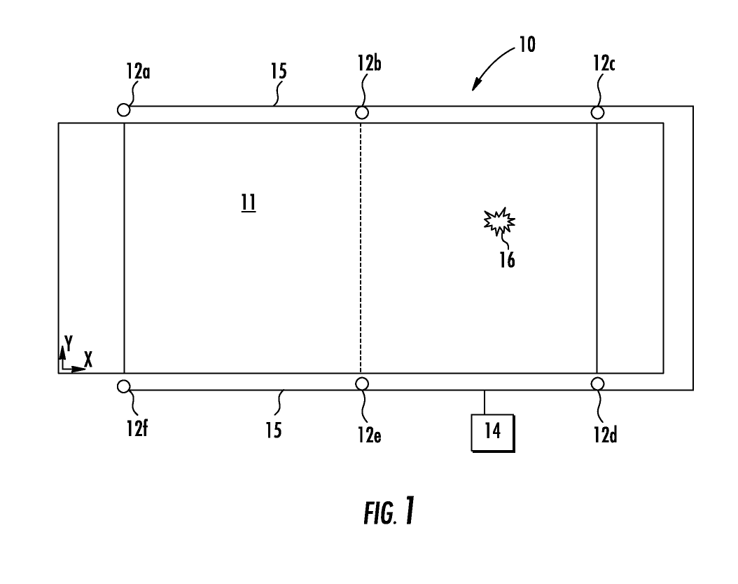

FIG. 1 illustrates an exemplary system 10 for remotely detecting a helmet collision on an athletic playing field. The system 10 includes six acoustical sensors 12a-12f disposed around the perimeter of the playing field, such as the football field shown in FIG. 1, and a data acquisition and processing device 14 in wired communication with the sensors 12a-12f. The sensors 12a-12f are disposed at known positions around the field. For example, the acoustical sensors 12a-12f may be special purpose acoustical sensors used for the detection of collision events, microphones dedicated to collecting acoustical signals from collision events, or microphones being used by media crews to record sounds from the athletic event. In certain implementations, the microphones used may include omnidirectional microphones, directional microphones, or a combination thereof. The sensors 12a-12f may be fixed to an existing structure of the field, or stadium/arena, or held in position by people on the sidelines of the field. In this system 10, the acoustical sensors 12a-12f are remotely located from the players on the athletic playing field. In addition, the sensors 12a-12f shown in FIG. 1 are wired to the device 14, allowing them to receive power from and communicate acoustical signals to the device 14. However, in other implementations (not shown), each sensor 12a-12f may be equipped with a wireless transmitter and individual power supply to wirelessly communicate acoustical signals to the device 14.

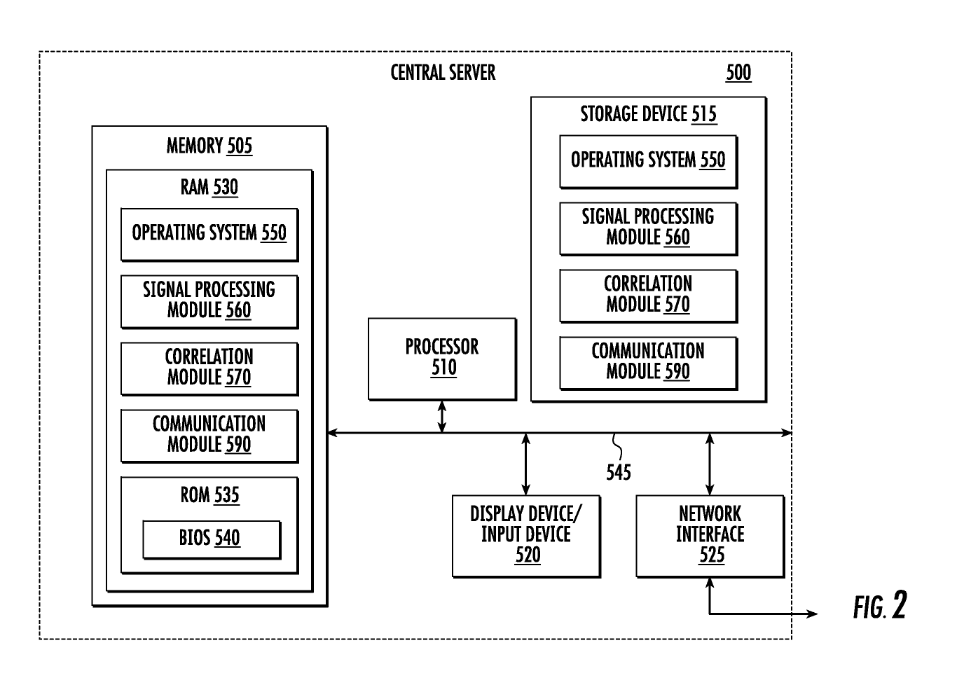

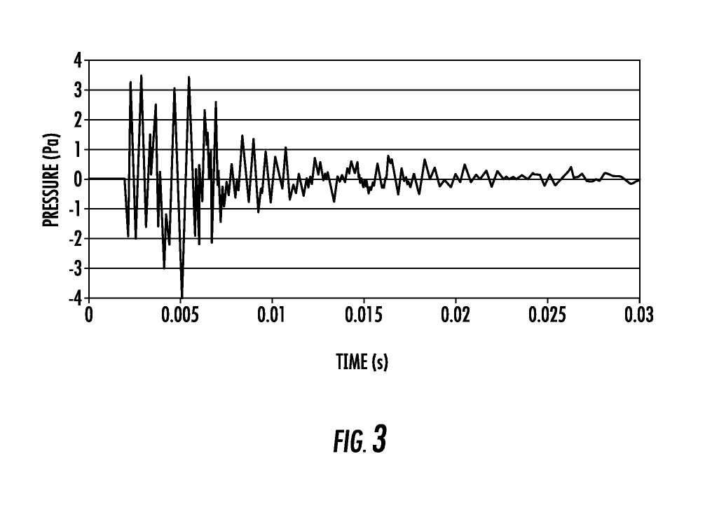

To process the signals received from the acoustical sensors 12a-12f, a computer system, such as the central server 500 shown in FIG. 2 is used, according to one implementation. The server 500 executes various functions of the collision detection system 10 described above in relation to FIG. 1 and below in relation to FIGS. 3 through 10. For example, the server 500 may be the data acquisition and processing device 14 described above, or a part thereof. As used herein, the designation “central” merely serves to describe the common functionality the server provides for multiple clients or other computing devices and does not require or infer any centralized positioning of the server relative to other computing devices. As may be understood from FIG. 2, in this implementation, the central server 500 may include a processor 510 that communicates with other elements within the central server 500 via a system interface or bus 545. Also included in the central server 500 may be a display device/input device 520 for receiving and displaying data. This display device/input device 520 may be, for example, a keyboard, pointing device, or touch pad that is used in combination with a monitor. The central server 500 may further include memory 505, which may include both read only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 515 may be connected to the system bus 545 by an appropriate interface. The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks. In addition, the server 500 may include a network interface 525 configured for communicating data with other computing devices.

A number of program modules may be stored by the various storage devices and within RAM 530. Such program modules may include an operating system 550 and a plurality of one or more modules, such as a signal processing module 560, a correlation module 570, and a communication module 590. The modules 560, 570, 590 may control certain aspects of the operation of the central server 500, with the assistance of the processor 510 and the operating system 550. For example, the modules 560, 570, 590 may perform the functions described and illustrated by the figures and other materials disclosed herein.

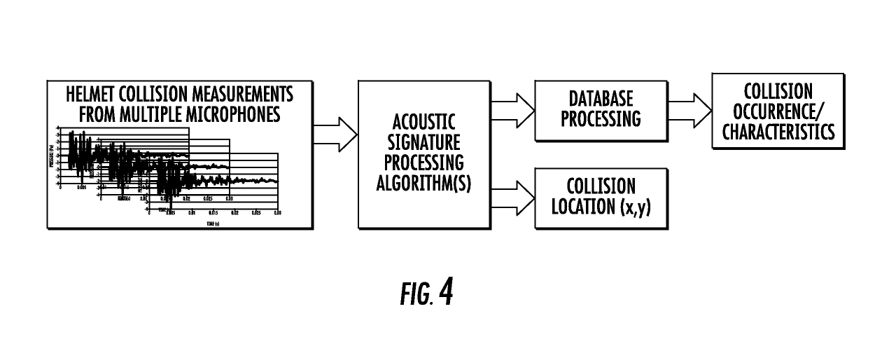

The functions described herein and the flowchart and block diagrams in FIGS. 4, 9, and 10 illustrate the architecture, functionality, and operation of possible implementations of systems, methods and computer program products according to various implementations of the present invention. Each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As shown in FIG. 4, acoustical signals, such as the acoustical signal shown in FIG. 3, are received from each acoustical sensor 12a-12f by the server 500 and are processed through one or more acoustic signature processing algorithms executed by the signal processing module 560. The algorithms provide whether a collision event has occurred and whether the collision event occurred within or outside of the boundaries of the athletic playing field. For example, the module 560 may detect whether a collision event has occurred by comparing an energy level of the received acoustical signal with a range of stored energy levels signals indicative of a collision event. In response to the energy level of the received signal being within the range, the module 560 identifies the received signal as indicating a collision event. In another example, the module 560 may determine if a helmet collision has occurred by comparing the acoustic pressure rise time and/or the frequency content of the acoustic collision signature with known parameters. In other implementations, the module 560 may detect whether a collision event has occurred by comparing a behavior of the received acoustical signal with one or more expected signal behaviors associated with a collision event.

The location of the collision event may be determined by using triangulation, the known locations of the sensors 12a-12f, and the various times at which the collision event is detected by each sensor 12a-12f. In one implementation, for example, multiple microphones are disposed at known locations around the playing field. These locations may be recorded as the x,y coordinates on the playing field, such as the field shown in FIG. 1. By using a single data acquisition system, such as device 14, the delay-time between the acoustic signatures at the microphone positions can be measured. This delay-time, or time-of-flight, may then be used to determine the location of the collision on the playing field by knowing the approximate speed of sound. By using more than three microphones, the local speed of sound may not be needed. Instead, the scaled timing between the measured acoustic signatures at the different microphones may be used to determine the collision location on the field. This approach also makes it possible to identify helmet collisions that might be occurring off the field. For example, suppose a player throws a helmet onto a sideline bench during a play on the field. By identifying the location of the helmet impact as being on the sideline, medical staff would know that a severe collision did not occur during the play on the field.

The use of multiple microphones also decreases the negative influence of background noise. Football stadiums, for example, are notoriously noisy environments. It is not expected that a microphone would be able to effectively measure a helmet collision acoustic signature that occurred all the way on the opposite end of the playing field. By having multiple microphones around the perimeter of the field, or even permanently mounted at various locations within the arena, the likelihood of a collision occurring in the vicinity of multiple microphones increases. In addition, identification of collision location on the field is important to identify which players may be involved in the collision.

As noted above, the module 560 may identify one or more characteristics of the collision event by processing the received acoustical signal and identifying one or more characteristics of the received acoustical signal. The signal characteristics of the acoustical signals define the acoustic signature of each acoustical signal and may include one or more of the following: acoustic pressure, acoustic energy, maximum acoustic pressure, signal duration, acoustic pressure at one or more discrete frequencies, acoustic pressure at one or more discrete natural frequencies corresponding to free vibration modes of the helmet, acoustic energy at one or more discrete frequencies, acoustic radiation mode maximum amplitude(s), acoustic radiation mode response amplitude versus time, energy in acoustic radiation mode(s), envelope of acoustic radiation mode(s) amplitude, and acoustic radiation mode amplitude decay. For example, the module 560 may identify the maximum acoustic pressure of the received acoustical signal and compare the identified maximum acoustic pressure to a range of expected acoustic pressures associated with each of one or more helmet collision force amounts. In response to the received maximum acoustic pressure being within the range of expected acoustic pressures associated with a particular force amount, the module 560 associates the particular force amount with the received acoustical signal. By knowing the position of the collision on the field from using the techniques noted above, the acoustic amplitudes can also be adjusted to account for spreading of acoustic energy as it propagates.

As noted above, the data gathered using the process described in FIG. 4 and the collision event characteristics of one or more collision events identified by the signal processing module 560 may be stored in the memory of the server 500. At least a portion of this data may be displayable on the display device of the server 500 or it may be communicated to and/or displayed on another computer device that is remotely located from the server 500 via wired or wireless communication. In addition, at least a portion of the data may be used by the module 560 to generate a message related to the collision event. For example, the message may indicate that a collision event occurred and/or include one or more characteristics of the collision event. For example, the message may indicate a severity level of the collision event based on one or more signal characteristics of the received acoustical signal. The message may also include the identified location of the collision event relative to the boundaries of the playing field.

The communication module 590 may receive the message generated by the signal processing module 560 and communicate the message to one or more display, audible, or haptic feedback devices, such as a display, audible, or haptic feedback device that is part of the server 500 or a display, audible, or haptic feedback device that is part of another computing device remotely located from and in wired or wireless communication with the server 500. For example, the computing device in communication with the server 500 may be statically disposed within a communication range of the acoustical sensors (e.g., a desktop computer or an alert monitor in the press box of the athletic field that alerts personnel when a collision event occurs) or portable (e.g., a smartphone or other portable feedback device held by personnel). This message may include a general indication that the collision event occurred (e.g., “severe collision” or “mild collision”) and/or an indication related to the severity of the impact (e.g., a force estimate, speed of the impact, resulting acceleration of the impact, scaled level of severity, a color related to severity), the location on the field, and the duration of the impact.

For example, the type of collision likely to be detected on a football field, such as the field shown in FIG. 1, is an impact with another helmet or with equipment worn by another player. However, this system may be implemented on other types of playing fields, such as a baseball field or a hockey rink, and the system may be configured to detect helmet collisions with other objects, such as a baseball or a hockey puck. In addition, the helmet may collide with a fixed object, such as a goal post, or a moveable object, such as another player or equipment carried by a player, such as a stick or bat.

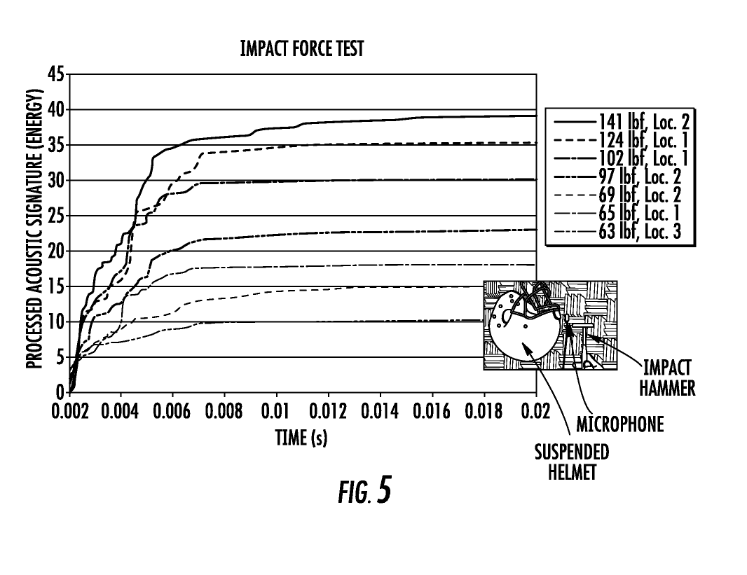

FIG. 5 illustrates how a processed acoustic signature may change with impact force levels according to one implementation. In particular, the acoustic signature for a suspended football helmet was measured after striking the helmet with an instrumented handheld hammer. The instrumented hammer enabled the magnitude and duration of the impact force to be measured. Several tests were conducted for multiple impact locations on the helmet and for the location of the acoustical sensor relative to the helmet. The measured acoustic signature was processed to obtain the acoustic energy level of the signal, and this energy level was associated with a single number, or value, that characterizes the impact severity. Thus, FIG. 5 illustrates the relationship between the acoustic energy level measured and the impact severity values. However, any one of many metrics could be used to quantify the severity of the impact. The energy level is merely used here as an example. The general behavior shown in FIG. 5 is that a larger impact force produces a larger value for the processed acoustic signature. In this example, only about 10 milliseconds of acoustic data is needed to determine the collision severity. This short data sample time helps reduce the negative effects of extraneous noise, though longer signals could certainly be considered. The use of wavelets is also helpful in reducing the negative effects of noise. Generally speaking, the final resulting signature value increases with increasing helmet impact force for the given acoustical sensor location. The square-root-sum-of-squares (SRSS) processing method is used to provide the information in FIG. 5. For example, in one such implementation, each time value corresponding to an acoustic pressure is squared to obtain a positive value. A running summation of these positive values is determined at each point in time, where the value at a specific time is the summation of all previous squared values. Finally, the square-root of the running summation at each time value is taken. In other implementations, other suitable processing methods may be used.

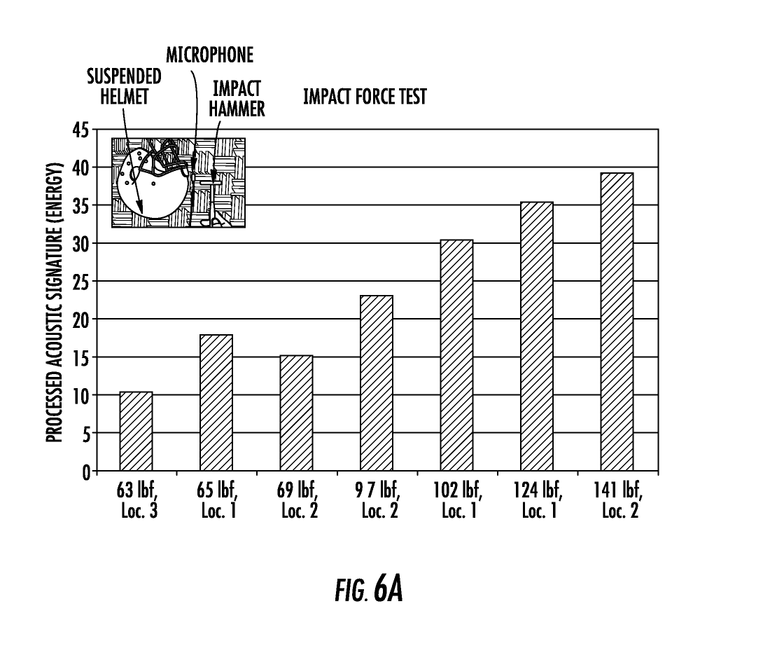

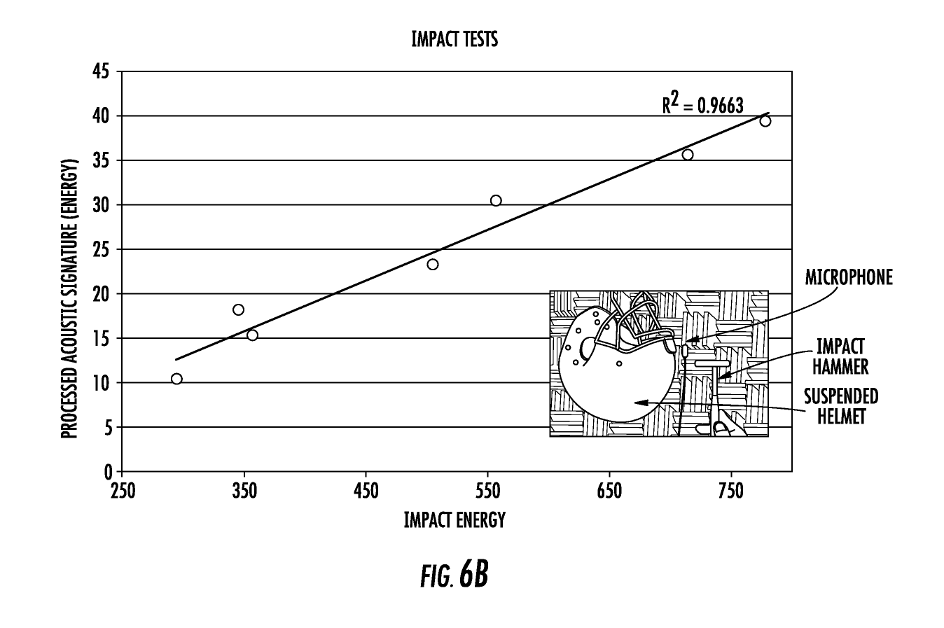

The relationship between the severity of the collision event and the acoustic signature is also demonstrated in FIGS. 6A and 6B. These figures show the acoustic signature energy as a function of impact force energy. Different impact forces were imposed at three different locations over the helmet. Thus, although the method used to process the acoustic data does not provide a perfect linear relationship between impact energy and acoustic energy, the relationship is still mostly linear for this simple demonstration. The square-root-sum-of-squares (SRSS) processing method was used to provide this information too, but other suitable processing methods may be used in other implementations. As shown, the energy of the acoustic signal increases proportionately with the force of the impact on the helmet. FIG. 6B illustrates that the R² for this correlation is 0.9663. Other methods for processing the acoustic signature to determine helmet impact severity, the collision location on the playing field, as well as possible impact location on the helmet, are contemplated as being within the scope of the invention, and some of which are discussed below.

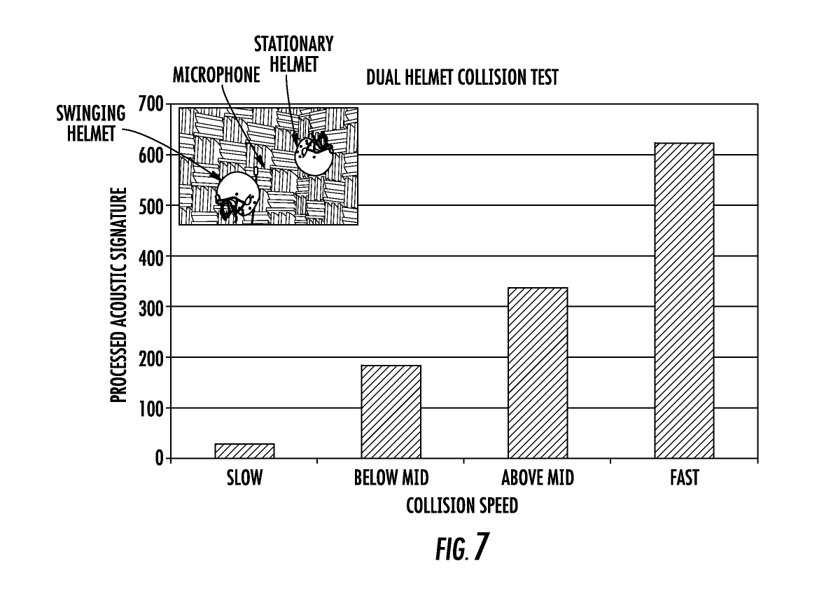

Another test was conducted in which the acoustic signature resulting from the collision of two helmets was measured. In this experiment, two helmets were suspended and the acoustic signature was measured as the helmets collided at various collision speeds. FIG. 7 illustrates the results for one potential acoustic processing method in which the resulting energy level increases with increasing collision speed. The square-root-sum-of-squares (SRSS) processing method was used to provide this information too, but other suitable processing methods may be used in other implementations.

Although the above described experiments consider the acoustic energy level of the acoustic signature in the processing method, other characteristics of the acoustic signature may be used to determine the characteristics of the collision event in other implementations. For example, the peak acoustic pressure, which is associated with an energy level of the signal in the time domain, may be compared with energy levels associated with known levels of force to identify the force associated with the collision event. In another implementation, the signal or a portion thereof may be transformed from the time domain to the frequency domain. For example, the processor may use a Fourier transform to transform at least a portion of the signal from the time domain to the frequency domain. One characteristic of that frequency-domain signal is the acoustic pressure at frequencies of interest and correlating those pressures with the force associated with the collision event. In another implementation, those frequencies of interest may correlate with the vibration mode frequencies of the helmet. In another implementation, the acoustic signal is compared to a set of wavelets that correlate with some characteristic of the helmet signature.

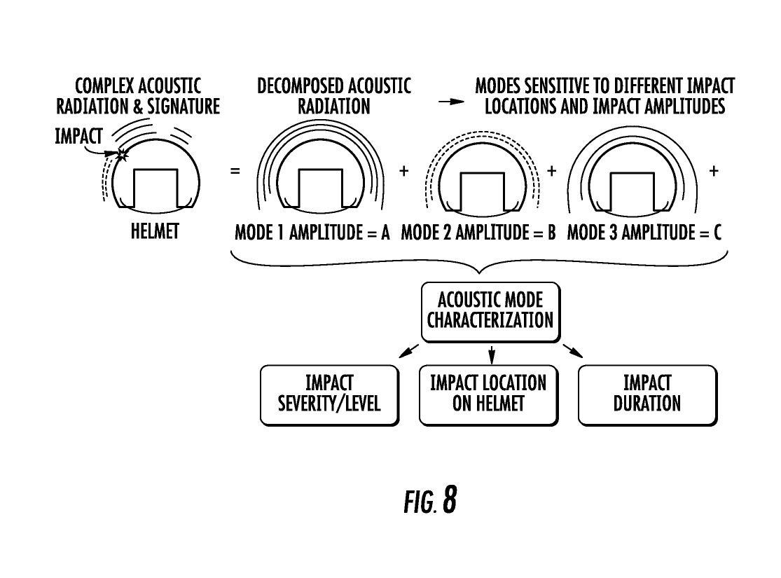

FIG. 8 illustrates a schematic of a decomposed acoustic radiation signature of an exemplary acoustic signal. The acoustic radiation signature is made up of various radiation mode amplitudes, such as mode 1 amplitude A, mode 2 amplitude B, and mode 3 amplitude C. These various radiation mode amplitudes may be used to identify the occurrence of the collision event, the severity level of the event, the speed of the impact, the acceleration of the impact, the duration of the impact, the force of the impact, the location and/or direction of the impact on the helmet, and/or other characteristics of the collision event.

Referring back to FIG. 8, structures radiate sound with certain characteristic that can be described using acoustic radiation modes. These acoustic radiation modes include an acoustic velocity distribution, or mode, over the surface of the structure, which is a helmet in this case. Note that these velocity distributions do not necessarily correlate with measurable quantities. These velocity distributions have a corresponding acoustic pressure distribution (mode), which depends on the structure (helmet) geometry and the frequency of interest. Each acoustic radiation mode has a corresponding radiation efficiency. By decomposing the measured acoustic signal into the acoustic radiation mode components, the characteristics of the collision event may be determined, such as the level of the impact force, the direction of the contact force between two helmets or the helmet and another object, and the force duration. These parameters are useful in assessing the severity of the helmet collision. Note that some of these same collision characteristics can also be determined using one or more of the other methods noted above.

Thus, various implementations allow for the use of collision event characteristics to evaluate the potential for head injury. This evaluation may be accomplished by correlating the results from the acoustic processing with results from experiments or real-time use in games or practice of instrumented helmets and players.

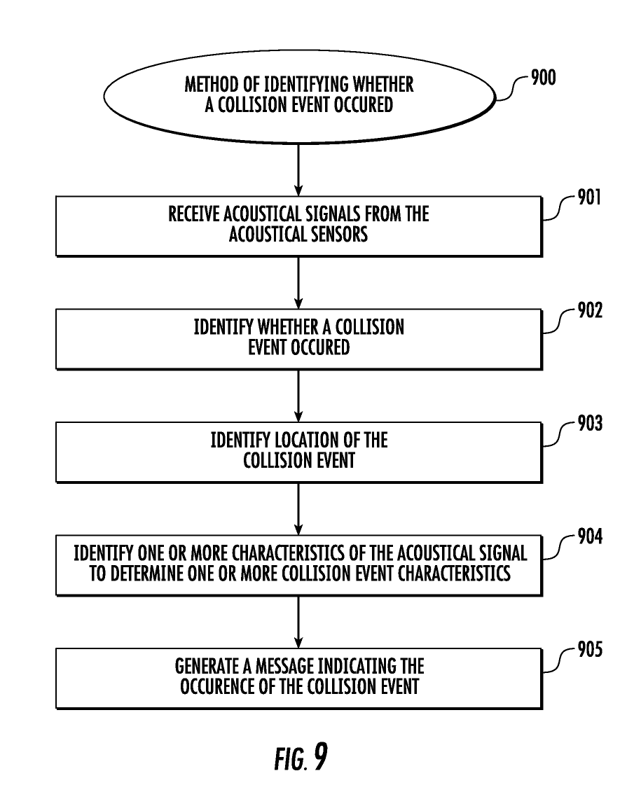

FIG. 9 illustrates a method 900 executed by the signal processing module 560 according to one implementation of identifying whether a collision event occurred, the location of the collision event, and characteristics of the collision event. In particular, the signal processing module 560 begins at step 901 by receiving acoustical signals from the acoustical sensors. Then, the module 560 identifies whether a collision event occurred at step 902. For example, the received acoustical signal is compared with a range of acoustical signals indicative of a helmet collision event, and in response to the received acoustical signal being within the range, identifying the received signal as indicating a collision event. If a collision event occurred, the module 560 then identifies the location of the collision at step 903. If the collision is identified as occurring within the boundaries of the playing field, the module 560 identifies one or more characteristics of the acoustical signal to determine one or more collision event characteristics, such as impact severity level, the impact location on the helmet, the duration of the impact, the force of the impact, the speed of the impact, and/or the acceleration of the impact at step 904. In other implementations (not shown), the signal processing module 560 may use other signal processing means (e.g., finite element analysis, Fourier transforms, etc.) in processing the acoustical signal, look up tables to identify the one or more collision event characteristics, or learning algorithms, such as a neural network, to “teach” the system the correlation, or relationship, between acoustical signal characteristics and collision event characteristics. In addition, if the collision is identified as occurring within the boundaries of the playing field, the module 560 may generate a message indicating the occurrence of the collision event, which is shown as step 905.

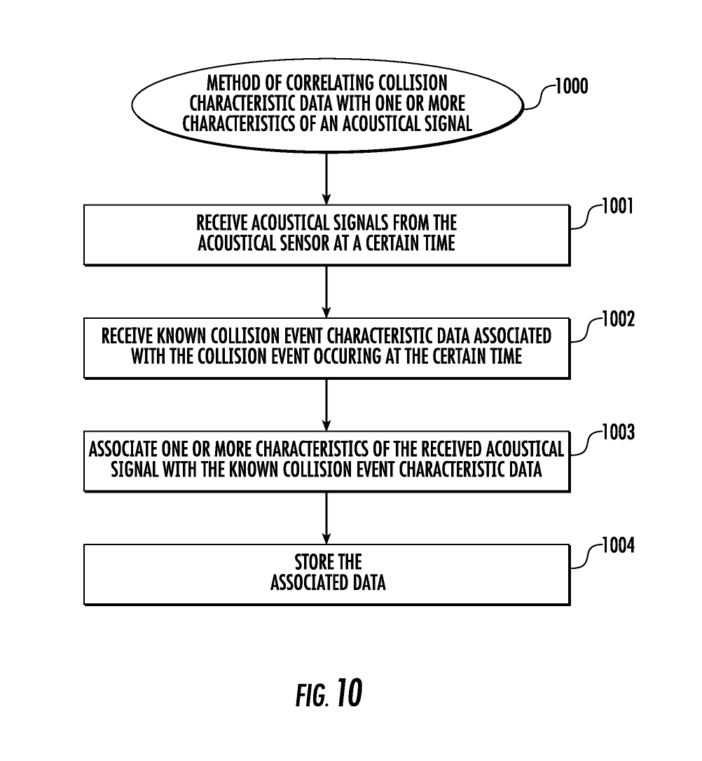

FIG. 10 illustrates a method 1000 of correlating a collision event with one or more acoustic signal characteristics executed by the correlation module 570, according to one implementation. The method 1000 begins at step 1001 with receiving an acoustical signal from the acoustical sensor at a certain time. Then, at step 1002, the correlation module 570 receives known collision characteristic data associated with the collision of the helmet and the object at the certain time. At step 1003, the correlation module 570 associates the received acoustical signal at the certain time with the known collision characteristic data. And, in step 1004, the correlation module 570 stores the associated data in the memory. The signal processing module 560 may use this data to identify one or more collision event characteristics based on the acoustical signal received for that collision event. As part of 1003, the correlation module 570 may associate one or more characteristics of the acoustical signal with the known collision characteristic data, as described in detail above.

The correlation module 570 may store the known collision event data with the received acoustical signals (and/or one or more acoustical signal characteristics thereof) that are associated with the collision event data in a look up table or library according to one implementation. However, in other implementations, the relationship between the known collision event data and the received acoustical signals (and/or one or more acoustical signal characteristics thereof) may be “learned” by the system using a neural network or other suitable computer implemented learning algorithm. In addition, the methods described in relation to FIGS. 5-7 may be used to acquire the relationship data stored by the system.

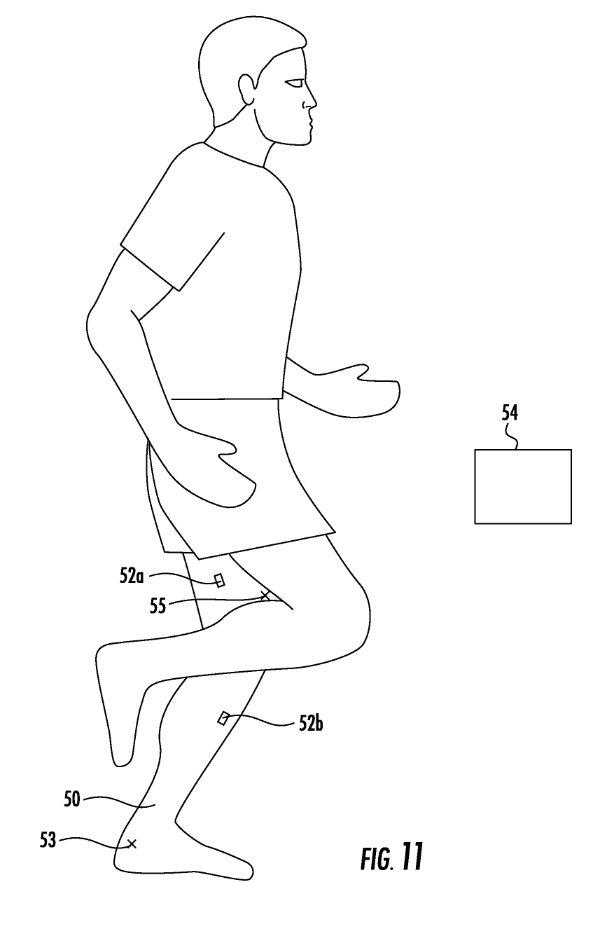

The implementations described above include systems and methods of detecting the collision of a helmet with another object. However, the systems and methods described above aren't limited to use with helmet collisions and could be used to remotely detect a collision of two or more other objects using acoustical sensors. And, the systems and methods described above for correlating a collision event of a helmet and another object with an acoustical signal could be used to correlate a collision event of two or more other types of objects with an acoustical signal. For example, as illustrated in FIG. 11, one or more acoustical sensors 52a, 52b may be disposed on the skin 50 of a human, and a force or other characteristic of a collision within the human (e.g., joints and/or bones colliding with each other) may be identified using an acoustical signal resulting from the collision. For example, as shown in FIG. 11, the acoustical sensors 52a, 52b disposed on the skin 50 of the human detect acoustical signals that result from the collision of the ankle 53 and/or knee joints 55 of the leg on which the sensors 52a, 52b are disposed. The acoustical signal travels through tissue and/or fluid in the human and is detected by the acoustical sensors 52a, 52b. The acoustical sensors 52a, 52b are remotely located from the colliding joints 53, 55, and a computing device 54 that includes a processor and a memory is in communication with the sensors 52a, 52b. The computing device 54 is also remotely located from the colliding joints 53, 55. The processor of the computing device 54 is configured for receiving an acoustical signal from the acoustical sensors 52a, 52b and identifying whether the acoustical signal indicates a collision event of the first object with the second object. In a further implementation, the processor is configured for storing data associated with the collision event in the memory in response to identifying the collision event. In addition, the processor may also be configured for identifying an amount of force, energy level, severity, duration, speed, acceleration, and/or location associated with the collision event and/or generating a message that includes one or more these identified characteristics.

The systems and methods recited in the appended claims are not limited in scope by the specific systems and methods of using the same described herein, which are intended as illustrations of a few aspects of the claims. Any systems or methods that are functionally equivalent are intended to fall within the scope of the claims. Various modifications of the systems and methods in addition to those shown and described herein are intended to fall within the scope of the appended claims. Further, while only certain representative systems and method steps disclosed herein are specifically described, other combinations of the systems and method steps are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

Any combination of one or more computer readable medium(s) may be used to implement the systems and methods described hereinabove. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), such as Bluetooth or 802.11, or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to implementations of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A system for remotely detecting a helmet collision on athletic playing field comprising:
at least one acoustical sensor disposed adjacent an athletic playing field, the acoustical sensor being remotely located from a player on the athletic playing field;
a computing device comprising a processor and a memory, the computing device being remotely located from one or more players participating within the boundary of the playing field, and the processor configured for:
receiving an acoustical signal from the acoustical sensor; and
identifying whether the acoustical signal indicates a collision event of an object with a helmet.

2. The system of claim 1, wherein the processor is further configured for identifying a location of the collision event relative to boundaries of the athletic playing field in response to identifying the collision event, and in response to the location being within the boundary of the athletic playing field, storing data associated with the collision event in the memory.

3. The system of claim 1, wherein the processor is further configured for identifying one or more characteristics of the acoustical signal indicative of the collision event, the one or more acoustical signal characteristics defining the acoustic signature of the acoustical signal.

4. The system of claim 3, wherein the one or more characteristics of the acoustical signal may be selected from the group consisting of: acoustic pressure, acoustic energy, maximum acoustic pressure, signal duration, acoustic pressure at one or more discrete frequencies, acoustic pressure at frequencies corresponding to the free-vibration modes of the helmet, acoustic energy at one or more discrete frequencies, wavelets, acoustic radiation mode maximum amplitude(s), acoustic radiation mode response amplitude versus time, energy in acoustic radiation mode(s), envelope of acoustic radiation mode(s) amplitude, and acoustic radiation mode amplitude decay.

5. The system of claim 4, wherein the processor is further configured for calculating an adjustment for the acoustic energy of the received acoustical signal based on a location on the playing field of the collision event, the adjustment being associated with an amount of spreading expected for the acoustic energy as the acoustical signal propagates from the collision event.

6. The system of claim 1, wherein the processor is further configured for converting at least a portion of the acoustical signal to a numerical value associated with an amount of force associated with the collision event, and storing the numerical value in the memory.

7. (canceled)

8. The system of claim 1, wherein the processor is further configured for identifying an energy level of the collision event and storing the identified energy level in the memory.

9.-12. (canceled)

13. The system of claim 1, wherein the processor is further configured for identifying an amount of force or severity associated with the collision event, storing the identified amount of force, and generating a message comprising the identified amount of force.

14. (canceled)

15. The system of claim 13, wherein the processor is further configured for identifying and storing in the memory a location and direction of impact of the force on the helmet, and the message further comprises the location and direction of impact on the helmet.

16. The system of claim 13, wherein identifying the amount of force associated with the collision event comprises comparing a maximum acoustic pressure associated with the received signal to a range of expected acoustic pressures associated with each of one or more force amounts, and identifying the amount of force associated with the range of expected acoustic pressures that includes the maximum acoustic pressure of the received signal.

17. The system of claim 1, wherein identifying whether the acoustical signal indicates the collision event comprises comparing a value associated with the acoustical signal to a range of expected values indicating the occurrence of the collision event.

18. The system of claim 1, wherein the processor is further configured for identifying a duration of the collision event, storing the duration in the memory, and generating a message comprising the duration of the collision event.

19. The system of claim 1, wherein the processor is further configured for identifying a speed or acceleration of the collision event, storing the speed or acceleration in the memory, and generating a message comprising the speed or acceleration.

20.-23. (canceled)

24. The system of claim 1, wherein the at least one acoustical sensor comprises a first acoustical sensor, a second acoustical sensor, and a third acoustical sensor, the first, second, and third acoustical sensors being remotely located from each other.

25.-37. (canceled)

38. A system for correlating a helmet collision event with an acoustical signal signature comprising:
a helmet and an object for colliding with the helmet;
at least one acoustical sensor disposed remotely from the helmet and the object; and
a computing device comprising a processor and a memory, the processor configured for:
receiving an acoustical signal from the acoustical sensor at a certain time;
receiving collision characteristic data associated with the collision of the helmet and the object at the certain time; and
associating the acoustical signal at the certain time with the collision characteristic data.

39. The system of claim 38, wherein the collision characteristic data comprises an amount of force at which the object is collided with the helmet, and the processor is further configured for associating the amount of force with an energy level of the acoustical signal associated with the collision event.

40. The system of claim 38, wherein the collision characteristic data comprises a duration for which the object is collided with the helmet, and the processor is further configured for associating the duration with the total acoustic energy of the collision.

41. The system of claim 38, wherein the collision characteristic data comprises a duration for which the object is collided with the helmet, and the processor is further configured for associating the duration with the duration of a vibration or acoustic mode signal associated with the helmet characteristics under collision.

42. The system of claim 38, wherein the collision characteristic data further comprises an impact location on the helmet at which the object is collided with the helmet, and the processor is further configured for associating the impact location with the amplitude of a helmet free-vibration mode or acoustic radiation mode of the acoustical signal associated with the collision event.

43.-46. (canceled)

47. A system for remotely detecting a collision of at least two objects comprising:
at least one acoustical sensor remotely located from a first object and a second object;
a computing device comprising a processor and a memory, the computing device being remotely located from the first and second objects, and the processor configured for:
receiving an acoustical signal from the acoustical sensor; and
identifying whether the acoustical signal indicates a collision event of the first object with the second object.

48. (canceled)
